(19) United States
(12) Patent Application Publication
(10) Pub. No.: US 2008/0059432 A1
(43) Pub. Date: Mar. 6, 2008

(54) System and method for database indexing, searching and data retrieval

(75) Inventors: Henry Kok Meng Tan, Singapore (SG); Hafeezur Rahman, Singapore (SG)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/820,171

(22) Filed: Jun. 18, 2007

(30) Foreign Application Priority Data
Sep. 1, 2006 (SG) 200606023-0

(51) Int. Cl. G06F 7/00

(52) U.S. Cl. 707/3; 707/100

(57) ABSTRACT

A method of searching a database, the database comprising a plurality of records stored in a machine readable device, each of the plurality of records comprising one or more of the plurality of documents; an index file comprising a plurality of device identifiers; each of the device identifier comprising a plurality of parameters identifiers; and each of the parameter identifier having real time value, the method comprising: selecting a device associated with the device identifier; selecting a parameter identifier associated with the selected device; receiving a search query comprising search criteria of the database; searching the database in response to the search query; displaying records satisfying the search criteria.

### FIELD OF THE INVENTION

The present invention relates generally to electronic data storage and retrieval. More particularly, the present invention relates to indexing, searching and data retrieval technologies including creation, organization, maintenance, and use of search indexes to accomplish the desired searching and data retrieval. Further, the present invention also relates to a method of searching and navigation field device parameter information.

### BACKGROUND

A tremendous amount of information in various fields of human knowledge is collected and stored in computer memory systems. As computer memory systems increasingly are linked to public available data communication networks, there has been an increasing effort to develop systems and methods for searching and retrieving information for public or personal use.

Information may be stored in the form of different data types, and in the context of information search and retrieval it will be useful to discern between dynamic data and static data. Dynamic data is data that changes often and continuously, so that the set of valid data shows real-time data, while static data only changes upon user request or after a pre-determined time interval. For instance economic data, such as stock values, or meteorological data is subjected to very quick changes and hence dynamic. On the other hand archival storage of books and documents are usually permanent and static data. The concept the volatility of the data relates to how long the information is valid. The volatility of data has some bearing upon how the information should be searched and retrieved. Large volumes of data require some structure in order to facilitate searching, but the time cost of building such structures must not be higher than the time the data is valid. The cost of building a structure is dependent on the data volume and hence the building of data structures for searching the information should take both the data volume and the volatility into consideration. The information collected are stored in databases and these may be structured or unstructured. Moreover, the databases may contain several types of documents, including compound documents which contain images, videos, sounds and formatted or annotated text. Particularly structured databases are usually furnished with indexes in order to facilitate searching and retrieving the data.

The ability to locate relevant documents from a large pool of documents is becoming increasingly desirable. Programs which provide this capability are commonly known as search engines. Search engines typically process a pool of documents and build an index of words. A user can enter a search request, or query, seeking a list of documents that contain certain words. The search engine processes the index and returns a list of documents that satisfy the request. Search engines are used frequently to determine which web sites on the Internet contain relevant content. Search engines are also used to access information from intranets, file servers, and databases. Given the vast amount of data that is electronically available, search engines are becoming increasingly important as a mechanism for finding relevant documents from a large pool of documents.

Efficiency is very important in search engine technology. While inefficient indexing and/or search processing may not be noticeable when the relevant pool of documents is relatively small, inefficiency will quickly lead to excessive index and search processing times when the pool of documents becomes relatively large. Efficiency is also an important consideration for other aspects of full text indexes, such as processing complex queries, or processing natural language queries. A search engine typically implements natural language searching by breaking a search request into multiple sub-queries. Consequently, if the searching algorithm is inefficient, response time can be seriously degraded.

A search request typically takes the form of one or more words separated by one or more logical operators, such as AND, OR, or NOT, and proximity restrictions, such as word ‘A’ within 10 words of word ‘B’. The search engine determines which documents satisfy the request, and returns a list of such documents.

A large number of documents may fulfill the search request where the pool, or set, of indexed documents is large. To help the user determine which documents will most likely contain relevant content, many search engines provide a ‘relevance’ ranking for each document that fulfills the search request. The relevance ranking is an estimation provided by the search engine of the importance of the document in view of the particular search request. The ability to rank and present documents to a user in order of their relevance is becoming increasingly important to minimize the time a user must spend in determining which of the many documents that fulfill the search request are, in fact, relevant. Ranking documents by relevance adds additional complexity to the search engine, and presents another potential efficiency consideration. Ideally, the relevance determination will not add significantly to the overall response time of the search engine.

One of the best mechanisms for increasing the efficiency of a search engine is to minimize peripheral input/output (I/O) operations, and in-memory table accesses. A full text index is typically made up of several tables of information, including cross-reference information, and during a search request, many different tables are accessed to make pertinent decisions, including determining in what document a particular word is located. Full text indexes can be very large, and can take up hundreds of megabytes or more of space. Because of its size, an entire full text index typically will not fit into the memory of a computer, so a table index access will likely result in at least one I/O operation to disk, and, depending on the access methodology, can result in multiple I/Os. An I/O operation is an extremely time-consuming process. Moreover, a single search request may require hundreds of thousands of table accesses, depending on the commonality of the word. Since eliminating or reducing I/O operations can significantly reduce response time, it is beneficial to reduce table accesses. One mechanism for reducing table accesses would be to store word information in a manner that the information itself allows for document level determinations to be made without the need to access a separate document level table.

### SUMMARY OF THE INVENTION

In accordance with a first aspect of the invention, there is provided a method of searching a database, the database comprising a plurality of records stored in a machine readable device, each of the plurality of records comprising one or more of the plurality of documents; an index file comprising a plurality of device identifiers; each of the device identifier comprising a plurality of parameters identifiers; and each of the parameter identifier having real time value, the method comprising: selecting a device associated with the device identifier; selecting a parameter identifier associated with the selected device; receiving a search query comprising search criteria of the database; searching the database in response to the search query; displaying records satisfying the search criteria.

In accordance with a second aspect of the invention, there is provided a system comprising a database, the database comprising: a plurality of records stored in a machine readable device, each of the plurality of records comprising one of more of the plurality of documents; an index file comprising a plurality of device identifiers; each of the device identifiers comprising a plurality of parameters identifiers; and each of the parameter identifiers having real time value.

Still other objects of the present invention will become apparent to those skilled in this art from the following description wherein there is shown and described preferred embodiments of this invention, simply by way of illustration, of one of the best modes contemplated for carrying out the invention. As will be realized, the invention is capable of other different obvious aspects all without departing from the invention. Accordingly, the drawings and description will be regarded as illustrative in nature and not as restrictive.

### BRIEF DESCRIPTION OF THE FIGURES

Further objects of this invention, together with additional features contributing thereto and advantages accruing therefrom, will be apparent from the following description of an embodiment of the present invention which is shown in the accompanying drawings with like reference numerals indicating corresponding parts throughout and which is to be read in conjunction with the following drawings, wherein:

FIG. 1 shows the organization of one embodiment of an index file in the database;

FIG. 2 a flowchart showing the typical steps used to identify and access records based on queries in accordance with the concepts of the present invention;

FIGS. 3 to 6 shows the user interface of one embodiment of the present invention.

These and additional embodiments of the invention may now be better understood by turning to the following detailed description wherein an illustrated embodiment is described.

### DETAILED DESCRIPTION OF THE PREFERRED EMBODIMENTS

Throughout this description, the embodiments and examples shown should be considered as exemplars, rather than limitations on the apparatus and methods of the present invention.

The present invention provides a system and method for data storage and retrieval in which data is stored in records within a database, and desired records are identified and/or selected by conducting searches of index files which map search criteria into the appropriate records. The overall organization, architecture, and use of the database may vary greatly depending upon the hardware and software operating environments involved.

As used herein, database refers to a collection of data files referred to as documents, and optionally the associated index files and other supporting files used to search, access and maintain the documents. A document may be an individual file in a specified format (e.g., HTML, text, JPEG, BMP, etc.), or a folder or directory which itself includes other documents. Relationships between various documents in a database may be defined within the database itself, or externally. A database is stored on a machine-readable medium.

As used herein, parameter refers to information of a device. A parameter can be the address itself, or it can be data used to calculate or determine the address.

### Index File Structure of the Present Invention

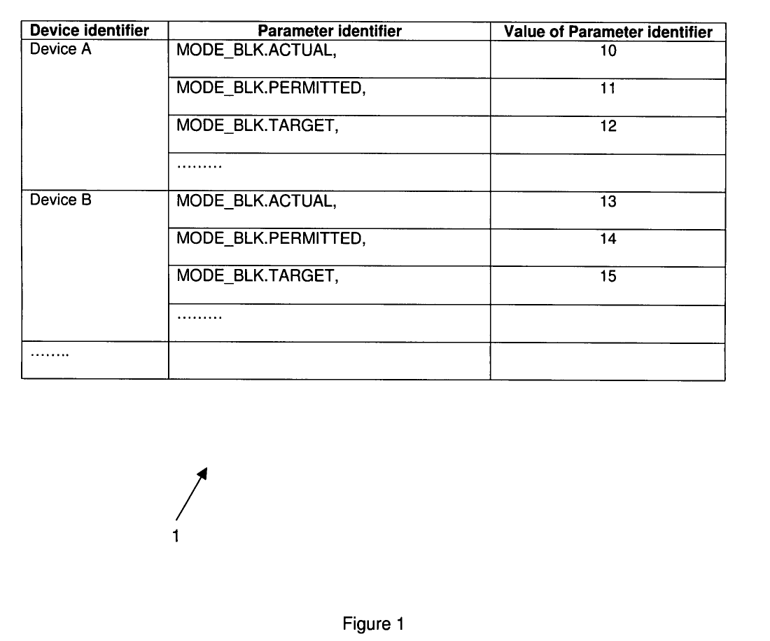

Turning to FIG. 1, the organization of one embodiment of an index file 1 in the database is shown. The index file 1 comprises a plurality of device identifiers and a plurality of parameter identifiers having real time values. It will be appreciated that the values of the parameter identifiers in FIG. 1 is arbitrary.

In the example as shown in FIG. 1, each of the device identifiers is associated with a specific device, for example an assembly device in a manufacturing plant. Each device identifier has at least one parameter identifier, for example MODE_BLK.ACTUAL, MODE_BLK.PERMITTED and MODE_BLK.TARGET, etc. Each of the parameter identifiers has a set of real-time values since the value may change over time, for example during different stages of the manufacturing process.

### Method of the Present Invention

As the present invention is directed to the actual structure of the index file, as well as uses thereof, the manner in which the index file is actually created is not critical. These files may be created using well-known programming algorithms, proprietor methods or a combination thereof, to effect the desired association for subsequent searches as described therein.

For example, the real time value of a parameter identifier may be created by manual data entry, or processing of a series of data files, or a combination thereof, with various error checking and formatting algorithms designed to ensure the integrity of each value. Similarly, once a record of real time values are created, the index file may be created by sequential processing of the record of the real time values, along with various sorting, merging, validation, and formatting algorithms.

The record of real time values may be maintained in real time or at various update intervals, and the index file and other files may likewise be updated or regenerated as needed to maintain synchronization with updated values. Other files may include, e.g. template files for defining document layouts; common query index files which map anticipated search queries to appropriate records; meta-files with associated meta-data sets with corresponding records for a specific volume; and meta-data sets with corresponding records for the entire database.

Once created, the index files are used to identify and/or select records by conducting searches of the index file which map search criterias into the appropriate records satisfying the search criteria. In a typical use of the present invention, a searcher or end user submits a search criteria to a software system implementing the concepts described herein, aimed at identifying parameter and its respective value which have characteristics associated therewith matching the search criteria. The database is then searched, and the records corresponding to the search criteria are identified and presented to the searcher. Multiple criteria may be specified in an initial query, in which case sub queries may be invoked and logical operations (such as AND'ing OR'ing, etc) may be performed on the resulting sets of identified records from each individual sub-query to yield a final result representing the records which satisfy the full search criteria.

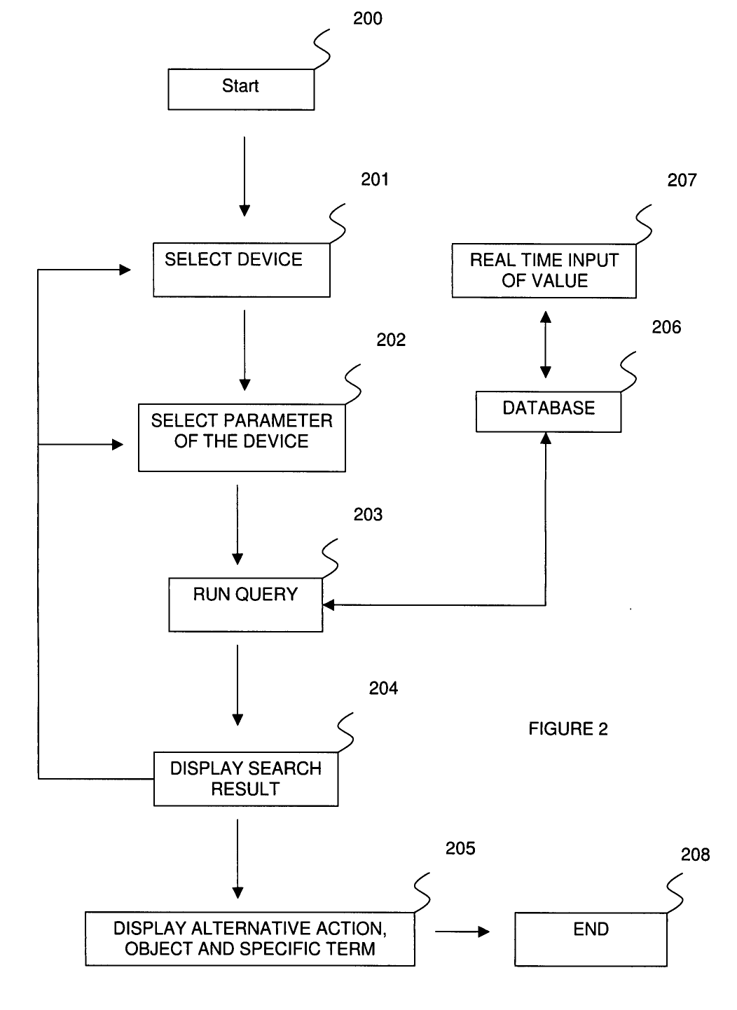

As a practical example of how an index file might be used in response to a query by a searcher, referring to FIG. 2, this example will presume the searcher has initiated a query for a specific device, for example the assembly device. Thereafter, the searcher further initiates a query for a parameter for the assembly device, for example MODE_BLK.TARGET. In accordance with the present invention, based on the source, type, or other information associated with the queries, the searching algorithm will identify the text index file as the index file to search. Because the search query is for the assembly device and its parameter MODE_BLK.TARGET, the real time value of the parameter will be located. This may be accomplished by, e.g. using calculations based upon a known fixed length of the parameter and a known collating character sequence, at the expense of only a single disk seek operation.

Turning to FIG. 2, a flowchart is shown illustrating the typical steps used to identify and assess records based on queries in accordance with the present invention. The steps shown are used to obtain records in response to a query or set of queries by a searcher. The process begins at step 200. At step 201, the searcher will select a specific device, such as an assembly device. Thereafter, at step 202, the searcher will select a parameter associated with the selected device. For example, the query type might be a query based upon a set of parameters, such as MODE_BLK.ACTUAL, MODE_BLK.PERMITTED and/or MODE_BLK.TARGET. Based on the nature and source of the query at step 202 at step 203, the query is conducted in the database 205. The records in the database 206 which are constantly updated by a user in step 207, will contain real time values of the parameters. The appropriate index file 1 to search might then be a text index file, a meta-data index file, a property index file, or a common query index file respectively.

Once the appropriate index file to search has been identified, at step 205, the real time value of the parameter(s) of the selected device will be displayed to the searcher. The searcher may have the option to view the historical value of the parameter(s) of the selected device as well. Further, the searcher may also navigate from one parameter to another parameter of the selected device, by activating a parameter value been displayed on the screen.

At step 205, it is determined whether the query has been satisfied, or if the query has been only partially satisfied. If there are queries that have been only partially satisfied, then the process proceeds to step 201, where the searcher will select another device or another parameter. In circumstance where queries are required for more than one device, the searcher may have the option to search for multiple devices and their respective parameters, so that that the overall search results may be viewed at the same time in one screen. If the queries have been fully satisfied, the searcher may choose to view the device parameter window, which will display alternative actions, objects and/or specific terms.

The present invention may also allow the searcher to search for devices that have not been configured, as well as verify that the devices have been properly configured during the commissioning of a new process plant.

Accordingly, the records are stored in a widely accepted data format, such as HTML or XML, and are therefore presented efficiently in a HTML or XML-compatible environment. That is, the records have complete display formatting data associated therewith, so that once the records satisfying the search criteria are identified and located, they may be retrieved and presented to the searcher on a display device without the need for dynamic page creation, formatting, etc.

The records each have a master document associated therewith, and may optionally have various view documents associated with each record in various styles, sizes, formats, and quantities. The various views of the selected records may be presented in response to requests therefore from the searcher. The view records are also formatted in HTML for efficient presentation in a HTML-compatible environment.

### User Interface of a Preferred Embodiment of the Present Invention

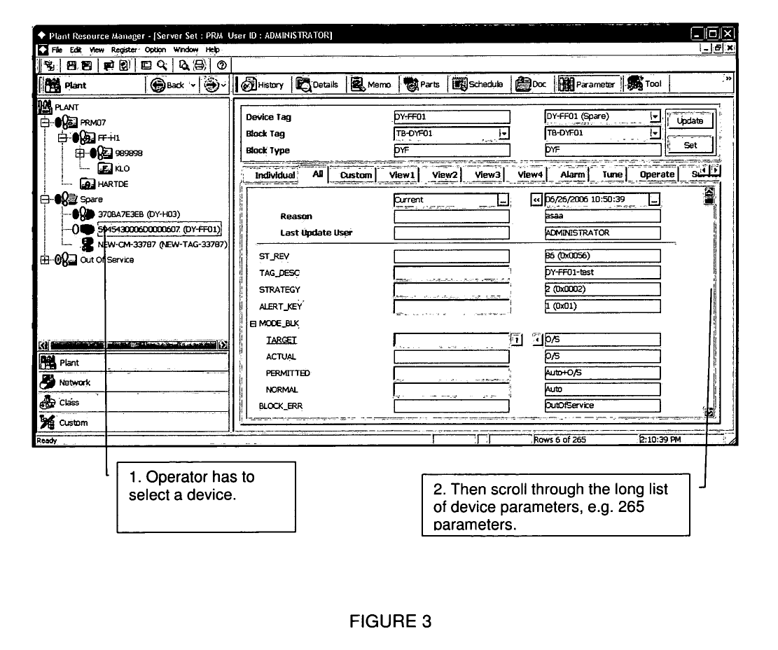

An user interface of a preferred embodiment of the present invention is illustrated from FIGS. 3 to 6.

FIG. 3 illustrates a user interface of step 201 of the present invention. In this instance, the searcher, for example a factory operator, selects a specific device from the interface, such as an assembly device.

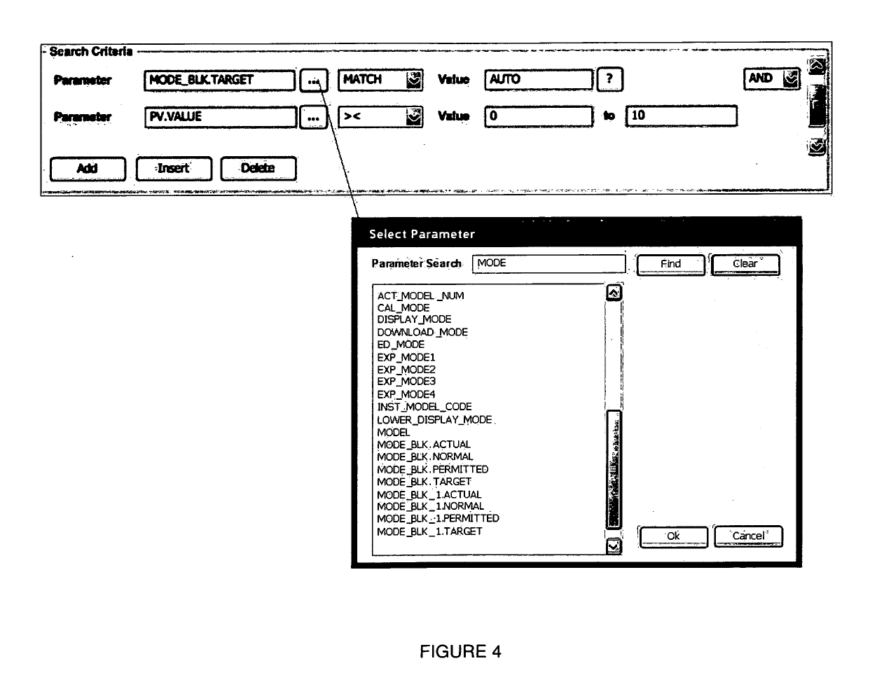

After the specific device is selected, the interface would prompt the searcher to select a parameter associated with the selected device, in accordance with step 202 of the present invention as shown in FIG. 4. For example, the query type might be a query based upon a set of parameters, such as MODE_BLK.ACTUAL, MODE_BLK.PERMITTED and MODE_BLK.TARGET. In this instance, the searcher selects the parameter MODE_BLK.TARGET.

Based on the nature and source of the query at step 202 at step 203, the query is conducted in the database 205. The records in the database 206 which are constantly updated by a user in step 207, will contain real time values of the parameters. The appropriate index file 1 to search might then be a text index file, a meta-data index file, a property index file, or a common query index file respectively.

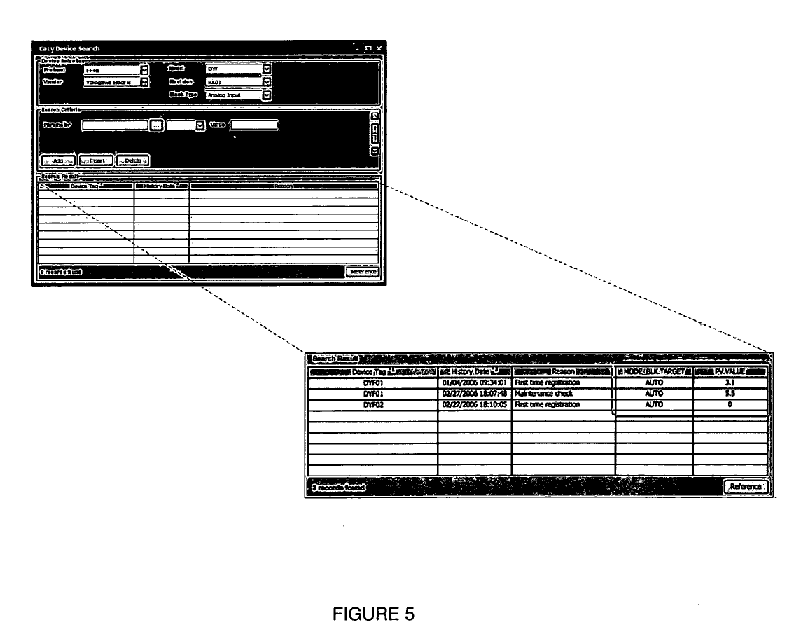

Once the appropriate index file to search has been identified, at step 205, the real time value of the parameter(s) of the selected device will be displayed to the searcher. The searcher may have the option to view the historical value of the parameter(s) of the selected device as well. Further, the searcher may also navigate from one parameter to another parameter of the selected device, by activating a parameter value been displayed on the screen. In this instance, as shown in FIG. 5, the historical values of the parameter MODE_BLK.TARGET of the selected device is displayed to the searcher. As shown, the values of the parameter MODE_BLK.TARGET of the selected device during first time registration and maintenance check are 3.1 and 5.5 respectively. In this instance, first time registration refer to the beginning stage when the searches register the device on the system while maintenance check refer to the stage when the searches if conducting a maintenance check.

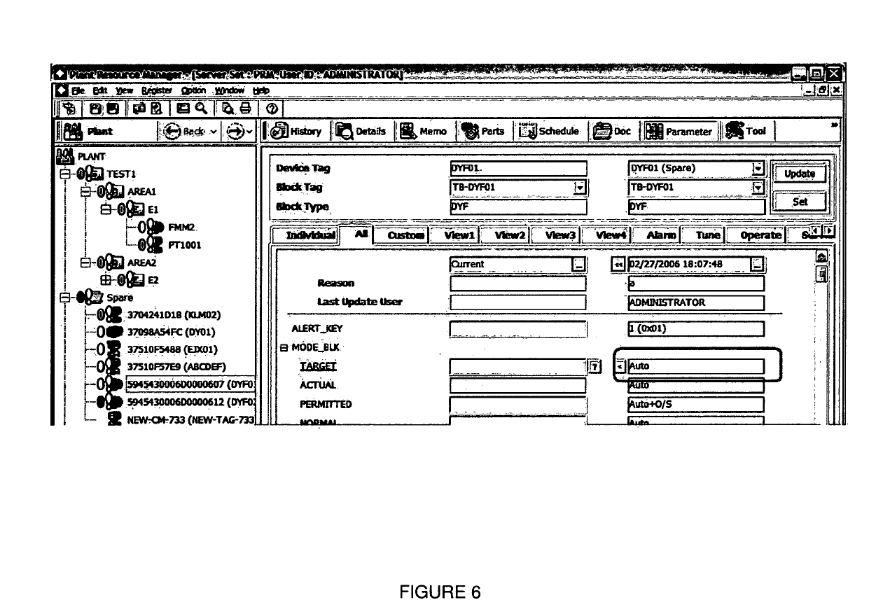

At step 205, it is determined whether the query has been satisfied, or if the query has been only partially satisfied. If there are queries that have been only partially satisfied, then the process proceeds to step 201, where the searcher will select another device or another parameter. In circumstance where queries are required for more than one device, the searcher may have the option to search for multiple devices and their respective parameters, so that that the overall search results may be viewed at the same time in one screen. If the queries have been fully satisfied, the searcher may choose to view the device parameter window, which will display alternative actions, objects and/or specific terms. In this instance, as shown in FIG. 6, a device parameter is displayed when the searcher selects on the parameter MODE_BLK.TARGET. As shown, the device parameter window displays greater details of the parameter MODE_BLK.TARGET, such as the last updated user, the reason, the target value of the parameter, the actual value of the parameter, the permitted value of the parameter, the normal value of the parameter, etc.

Accordingly, the records are stored in a widely accepted data format, such as HTML or XML, and are therefore presented efficiently in a HTML or XML-compatible environment. That is, the records have complete display formatting data associated therewith, so that once the records satisfying the search criteria are identified and located, they may be retrieved and presented to the searcher on a display device without the need for dynamic page creation, formatting, etc.

The records each have a master document associated therewith, and may optionally have various view documents associated with each record in various styles, sizes, formats, and quantities. The various views of the selected records may be presented in response to requests therefore from the searcher. The view records are also formatted in HTML for efficient presentation in a HTML-compatible environment.

Although exemplary embodiments of the present invention have been shown and described, it will be apparent to those skilled in the art that a number of changes, modifications, or alternations to the invention as described herein may be made, none of which depart from the spirit of the present invention. All such changes, modifications and alterations should therefore be seen as within the scope of the present invention.

1. A method of searching a database, the database comprising a plurality of records stored in a machine readable device, each of the plurality of records comprising one or more of the plurality of documents; an index file comprising a plurality of device identifiers; each of the device identifier comprising a plurality of parameters identifiers; and each of the parameter identifier having real time value, the method comprising:
selecting a device associated with the device identifier;
selecting a parameter identifier associated with the selected device;
receiving a search query comprising search criteria of the database;
searching the database in response to the search query;
displaying records satisfying the search criteria.

2. The method according to claim 1, wherein the records has corresponding complete display formatting data associated therewith, and further comprising the step of displaying the records on a display device in a format specified by the corresponding complete display formatting data.

3. The method according to claim 1 or 2, wherein the records comprising a first assessed record comprising a master document and a view document.

4. The method according to any one of the preceding claims, wherein the index file is a meta-data file.

5. The method according to any one of the preceding claims, wherein the display shows the records having corresponding complete display formatting data associated with one or more device.

6. The method according to any one of the preceding claims, wherein a searcher may navigate from one parameter identifier to another parameter identifier of the selected device, by activating a parameter value been displayed.

7. A system comprising a database, the database comprising:
a plurality of records stored in a machine readable device, each of the plurality of records comprising one of more of the plurality of documents;
an index file comprising a plurality of device identifiers;
each of the device identifiers comprising a plurality of parameters identifiers; and
each of the parameter identifiers having real time value.

8. The method according to claims 7, wherein the records has corresponding complete display formatting data associated therewith.

9. The system according to claims 7 or 8, wherein the records comprising a first assessed record comprising a master document and a view document.

10. The system according to any one of claims 7 to 9, wherein the index file is a meta-data file.
